(19) United States
(12) Patent Application Publication
(10) Pub. No.: US 2006/0240995 A1
(43) Pub. Date: Oct. 26, 2006

(54) Methods of using resins in subterranean formations

(75) Inventors: Richard D. Rickman, Duncan, OK (US); Philip D. Nguyen, Duncan, OK (US)

Correspondence Address: Robert A. Kent, 2600 S. 2nd Street, Duncan, OK, 73536-0440, US

(73) Assignee: Halliburton Energy Services, Inc.

(21) Appl. No.: 11/112,988

(22) Filed: Apr. 23, 2005

(51) Int. Cl. C09K 8/56

(52) U.S. Cl. 507/219; 507/233

(57) ABSTRACT

Improved methods of using resins to consolidate particulates in relatively unconsolidated portions of a subterranean formation. In certain embodiments, the methods comprise: applying a preflush fluid to at least a portion of a subterranean formation; applying a resin composition to the portion of the subterranean formation, the resin composition comprising a liquid hardenable resin component that comprises a hardenable resin and a solvent, and a liquid hardening agent component that comprises a hardening agent, a solvent, a silane coupling agent, and a non-ionic surfactant; and applying a compatible afterflush fluid to the portion of the subterranean formation.

### BACKGROUND

The present invention relates to methods of treating subterranean formations, and more particularly, to improved methods of using resins to consolidate particulates in relatively unconsolidated portions of a subterranean formation.

Hydrocarbon wells are often at least partially located unconsolidated portions of a subterranean formation. As used herein, the term “unconsolidated portion of a subterranean formation” is used to mean a portion of a subterranean formation that comprises loose particulate matter that can migrate out of the formation with, among other things, the oil, gas, water, and/or other fluids recovered out of the well. The particulate material in a relatively unconsolidated portion of a subterranean formation may be readily entrained by recovered fluids, for example, those wherein the particulates in that portion of the subterranean formation are bonded together with insufficient bond strength to withstand the forces produced by the production of fluids through those regions of the formation. The presence of particulate matter, such as sand, in the recovered fluids is disadvantageous and undesirable in that the particulates may abrade pumping and other producing equipment and reduce the fluid production capabilities of certain portions of a subterranean formation.

One method of controlling loose sands in unconsolidated portions of subterranean formations involves placing a filtration bed of gravel near the portion of the formation surrounding a well bore in order to present a physical barrier to the transport of unconsolidated formation fines from the formation to the well bore with the production of hydrocarbons. Such operations are typically known as “gravel packing operations.” Generally, gravel packing operations are time consuming and expensive.

Another method used to control loose sands in unconsolidated portions of subterranean formations involves consolidating the particulates in the area of interest into hard, permeable masses. This is usually accomplished by pre-flushing the unconsolidated portion of the formation, applying a hardenable resin composition, applying a spacer fluid, applying an external catalyst to cause the resin to set, and applying an afterflush fluid to remove excess resin from the pore spaces of that portion of the formation. Such multiple-component resin applications, however, often create a risk for undesirable results. For example, when an insufficient amount of spacer fluid is used between the application of the hardenable resin and the application of the external catalyst, the resin may come into contact with the external catalyst in a portion of the well bore itself rather than in the unconsolidated portion of the subterranean formation. When this occurs, it can be very problematic. When resin is contacted with an external catalyst, an exothermic reaction occurs that may result in rapid polymerization of the hardenable resin into a hardened mass. The hardened mass may cause many problems including: impairing the permeability of the formation by plugging the surrounding pore channels; halting pumping of fluids into and/or out of the formation; or causing a downhole explosion as a result of the heat of polymerization. Also, using these conventional multi-component resin processes to treat long intervals of unconsolidated portions is not practical due to the difficulty in determining if the entire interval that has been treated with both the resin and the activation agent.

### SUMMARY

The present invention relates to methods of treating subterranean formations, and more particularly, to improved methods of using resins to consolidate particulates in relatively unconsolidated portions of a subterranean formation.

In one embodiment, the present invention provides a method comprising: applying a preflush fluid to at least a portion of a subterranean formation; applying a resin composition to the portion of the subterranean formation, the resin composition comprising a liquid hardenable resin component that comprises a hardenable resin and a solvent, and a liquid hardening agent component that comprises a hardening agent, a solvent, a silane coupling agent, and a non-ionic surfactant; and applying a compatible afterflush fluid to the portion of the subterranean formation.

In another embodiment, the present invention provides a method of stabilizing a relatively unconsolidated portion of a subterranean formation comprising: applying a preflush fluid to the portion of the subterranean formation; applying a resin composition to the portion of the subterranean formation, the resin composition comprising a liquid hardenable resin component that comprises a hardenable resin and a solvent, and a liquid hardening agent component that comprises a hardening agent, a solvent, a silane coupling agent, and a non-ionic surfactant; and applying a compatible afterflush fluid to the portion of the subterranean formation.

In another embodiment, the present invention provides a method of creating a permeable, consolidated formation sand pack in a relatively unconsolidated portion of a subterranean formation comprising: applying a preflush fluid to the portion of the subterranean formation; applying a resin composition to the portion of the subterranean formation, the resin composition comprising a liquid hardenable resin component that comprises a hardenable resin and a solvent, and a liquid hardening agent component that comprises a hardening agent, a solvent, a silane coupling agent, and a non-ionic surfactant; applying a compatible afterflush fluid to the portion of the subterranean formation; and waiting a sufficient amount of time for the hardenable resin to cure so as to form a permeable, consolidated formation sand pack.

The features and advantages of the present invention will be apparent to those skilled in the art. While numerous changes may be made by those skilled in the art, such changes are within the spirit of the invention.

### DESCRIPTION OF PREFERRED EMBODIMENTS

The present invention relates to methods of treating subterranean formations, and more particularly, to improved methods of using resins to consolidate particulates in relatively unconsolidated portions of a subterranean formation.

The methods of the present invention comprise: applying a preflush fluid to at least a portion of a subterranean formation, applying a resin composition of the present invention to the portion of the subterranean formation, applying a compatible afterflush fluid to the portion to the subterranean formation. As used herein, the term “compatible afterflush fluid” refers to an afterflush fluid that is chosen vis-à-vis the chosen hardenable resin such that the hardenable resin is substantially insoluble in the afterflush fluid. In certain embodiments, the methods may also comprise waiting a sufficient amount of time for the hardenable resin in the resin composition to cure. In certain embodiments, the methods of the present invention may be used in portions of subterranean formations with temperatures in the range of from about 200° F. to about 400° F. Subterranean formations treated using the methods of the present invention may, among other things, exhibit high retained permeability values reflecting that the permeability of the treated formations remains high after the treatment. High retained permeability values generally translate into better production from the subterranean formation.

The resin compositions utilized in the present invention comprise a liquid hardenable resin component and a liquid hardening agent component. The liquid hardenable resin component comprises a hardenable resin and a solvent. The liquid hardening agent component comprises a hardening agent, a solvent, a silane coupling agent, and a non-ionic surfactant.

Examples of hardenable resins that can be used in the liquid hardenable resin component include, but are not limited to, organic resins such as bisphenol A diglycidyl ether resin, butoxymethyl butyl glycidyl ether resin, bisphenol A-epichlorohydrin resin, polyepoxide resin, novolak resin, polyester resin, phenol-aldehyde resin, urea-aldehyde resin, furan resin, urethane resin, a glycidyl ether resin, and combinations thereof. The hardenable resin used may be included in the liquid hardenable resin component in an amount in the range of from about 50% to about 100% by weight of the liquid hardenable resin component. In some embodiments, the hardenable resin used may be included in the liquid hardenable resin component in an amount of about 60% to about 90% by weight of the liquid hardenable resin component.

Any solvent that is compatible with the hardenable resin and achieves the desired viscosity effect is suitable for use in the liquid hardenable resin component of the resin compositions utilized in the present invention. Solvents having high flash points (e.g., about 125° F.) may be particularly suitable for the methods of the present invention because of, among other things, environmental and safety concerns. Such solvents include butyl lactate, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene, fatty acid methyl esters, and combinations thereof. Other suitable solvents include aqueous dissolvable solvents such as, methyl alcohol, ethyl alcohol, isopropyl alcohol, butyl alcohol, glycol ether solvents, and combinations thereof. Suitable glycol ether solvents include, but are not limited to, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof. Selection of an appropriate solvent is dependent on the resin composition chosen and is within the ability of one skilled in the art with the benefit of this disclosure. In some embodiments, the solvent may be present in the liquid hardenable resin component in an amount in the range of from about 0.1% to about 30% by weight of the liquid hardenable resin component.

Examples of the hardening agents that can be used in the liquid hardening agent component of the resin compositions utilized in the present invention include, but are not limited to, piperazine, derivatives of piperazine (e.g., aminoethylpiperazine), 2H-pyrrole, pyrrole, imidazole, pyrazole, pyridine, pyrazine, pyrimidine, pyridazine, indolizine, isoindole, 3H-indole, indole, 1H-indazole, purine, 4H-quinolizine, quinoline, isoquinoline, phthalazine, naphthyridine, quinoxaline, quinazoline, 4H-carbazole, carbazole, β-carboline, phenanthridine, acridine, phenathroline, phenazine, imidazolidine, phenoxazine, cinnoline, pyrrolidine, pyrroline, imidazoline, piperidine, indoline, isoindoline, quinuclindine, morpholine, azocine, azepine, 2H-azepine, 1,3,5-triazine, thiazole, pteridine, dihydroquinoline, hexa methylene imine, indazole, amines, aromatic amines, polyamines, aliphatic amines, cyclo-aliphatic amines, amides, polyamides, 2-ethyl-4-methyl imidazole, 1,1,3-trichlorotrifluoroacetone, and combinations thereof. The chosen hardening agent often effects the range of temperatures over which a hardenable resin is able to cure.

By way of example and not of limitation, in subterranean formations having a temperature from about 60° F. to about 250° F., amines and cyclo-aliphatic amines such as piperidine, triethylamine, N,N-dimethylaminopyridine, benzyldimethylamine, tris(dimethylaminomethyl)phenol, and 2-(N₂N-dimethylaminomethyl)phenol are preferred with N,N-dimethylaminopyridine most preferred. In subterranean formations having higher temperatures, 4,4′-diaminodiphenyl sulfone may be a suitable hardening agent. Hardening agents that comprise piperazine or a derivative of piperazine have been shown capable of curing various hardenable resins from temperatures as low as about 70° F. to as high as about 400° F. The hardening agent used is included in the liquid hardening agent component in an amount sufficient to consolidate the particulates in the formation. In some embodiments of the present invention, the hardening agent may be included in the liquid hardening agent component in an amount in the range of from about 40% to about 60% by weight of the liquid hardening agent component. In some embodiments, the hardening agent may be included in the liquid hardening agent component in an amount in the range of from about 45% to about 55% by weight of the liquid hardening agent component.

Any solvent that is compatible with the hardening agent and achieves the desired viscosity effect is suitable for use in the liquid hardening agent component of the resin compositions utilized in the present invention. Solvents having high flash points (e.g., about 125° F.) may be particularly suitable for the methods of the present invention because of, among other things, environmental and safety concerns. Such solvents include butyl lactate, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene, fatty acid methyl esters, and combinations thereof. Other suitable solvents include aqueous dissolvable solvents such as, methyl alcohol, ethyl alcohol, isopropyl alcohol, butyl alcohol, glycol ether solvents, and combinations thereof. Suitable glycol ether solvents include, but are not limited to, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof. Selection of an appropriate solvent is dependent on the resin composition chosen and is within the ability of one skilled in the art with the benefit of this disclosure.

The silane coupling agent may act as; among other things, a mediator to help bond the resin to formation particulates and/or proppant. Examples of suitable silane coupling agents include, but are not limited to, N-β-(aminoethyl)-γ-aminopropyl trimethoxysilane, N-2-(aminoethyl)-3-aminopropyltrimethoxysilane, 3-glycidoxypropyltrimethoxysilane, and combinations thereof. The silane coupling agent used may be included in the hardening agent component in an amount capable of sufficiently bonding the resin to the particulate. In some embodiments of the present invention, the silane coupling agent may be included in the liquid hardening agent component in an amount in the range of from about 0.1% to about 3% by weight of the liquid hardening agent component.

Any non-ionic surfactant compatible with the hardening agent and capable of facilitating the coating of the resin onto particles in the subterranean formation may be used in the liquid hardening agent component of the resin compositions utilized in the present invention. Examples of such non-ionic surfactants include, but are not limited to, ethoxylated nonyl phenol phosphate esters. The non-ionic surfactant in the resin compositions utilized in the present invention also may comprise a mixture of any such surfactants. In certain embodiments, the surfactant or surfactants may be included in the liquid hardening agent component in an amount in the range of from about 1% to about 10% by weight of the liquid hardening agent component.

The resin compositions utilized in the present invention may optionally comprise a hydrolysable ester that can be used in the liquid hardening agent component. Examples of such hydrolysable esters include, but are not limited to, a mixture of dimethylglutarate, dimethyladipate, dimethylsuccinate, sorbitol, catechol, dimethylthiolate, methyl salicylate, dimethyl salicylate, dimethylsuccinate, ter-butylhydroperoxide, and combinations thereof. When used, a hydrolysable ester is included in the liquid hardening agent component in an amount in the range of from about 0.1% to about 5% by weight of the liquid hardening agent component. In some embodiments, a hydrolysable ester may be included in the resin composition in an amount in the range of from about 1% to about 3% by weight of the liquid hardening agent component.

Use of a liquid carrier fluid in the hardenable resin composition is optional and may be used to reduce the viscosity of the hardenable resin component for ease of handling, mixing and transferring. It is within the ability of one skilled in the art, with the benefit of this disclosure, to determine if and how much liquid carrier fluid is needed to achieve a viscosity suitable to the subterranean conditions. Any suitable carrier fluid that is compatible with the hardenable resin and achieves the desired viscosity effects is suitable for use in the present invention. Liquid carrier fluids having high flash points (e.g., about 125° F.) may be particularly suitable for the methods of the present invention because of, among other things, environmental and safety concerns. Examples of suitable liquid carrier fluids include, but are not limited to, butyl lactate, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene, fatty acid methyl esters, and combinations thereof. Other suitable liquid carrier fluids include aqueous dissolvable solvents such as, methyl alcohol, ethyl alcohol, isopropyl alcohol, butyl alcohol, glycol ether solvents, and combinations thereof. Suitable glycol ether liquid carrier fluids include, but are not limited to, ethers of a C₂ to C₆ dihydric alkanol containing at least one C₁ to C₆ alkyl group, mono ethers of dihydric alkanols, methoxypropanol, butoxyethanol, hexoxyethanol, and isomers thereof. Selection of an appropriate liquid carrier fluid is dependent on the resin composition chosen and is within the ability of one skilled in the art with the benefit of this disclosure.

The preflush fluids utilized in the methods of the present invention may comprise an aqueous liquid or a non-aqueous liquid. The preflush fluid, inter alia, may ready the formation to receive the resin composition and/or remove formation fluids and/or oils that may impede the resin composition from making contact with the formation sands. Examples of aqueous liquids suitable for the preflush fluids utilized in the methods of the present invention include, but are not limited to, salt water, brine or any other aqueous liquid that does not adversely react with the other components used in accordance with the present invention. Examples of non-aqueous liquids suitable for the preflush fluids utilized in the methods of the present invention include, but are not limited to, diesel, kerosene, or any other hydrocarbon liquid that does not adversely react with the other components used in accordance with the present invention.

The compatible afterflush fluid may act, inter alia, to displace the curable resin from the well bore, to remove excess curable resin from the pore spaces inside the subterranean formation, and/or to remove any solvent remaining in the subterranean formation, thereby restoring permeability and leaving behind some resin at the contact points between formation sand particulate to form a permeable, consolidated formation sand pack. The compatible afterflush fluid utilized in the methods of the present invention may comprise either an aqueous liquid or a non-aqueous liquid, so long as the chosen hardenable resin is substantially insoluble in the compatible afterflush fluid. In certain embodiments, the compatible afterflush fluid may comprise fresh water, salt water, brine, or any other aqueous liquid that does not adversely react with the other components used in accordance with the present invention. In certain embodiments, the compatible afterflush fluid may comprise diesel, kerosene, or any other hydrocarbon liquid that does not adversely react with the other components used in accordance with the present invention. In certain embodiments, the volume of the compatible afterflush fluid may be at least about equal to the volume of the resin composition used in the same method.

The chosen period of time needed for the hardenable resin to cure will depend on the resin composition used, the temperature of the formation, and the unconfined compressive strength needed in the particular application. Generally, the chosen period of time may be between about 0.5 hours and about 72 hours. In certain embodiments, the chosen period of time may be between about 6 hours and about 48 hours. Determining the proper cure time is within the ability of one skilled in the art with the benefit of this disclosure.

Therefore, the present invention is well adapted to attain the ends and advantages mentioned as well as those that are inherent therein. While numerous changes may be made by those skilled in the art, such changes are encompassed within the spirit of this invention as defined by the appended claims. The terms in the claims have their plain, ordinary meaning unless otherwise explicitly and clearly defined by the patentee.

What is claimed is:

1. A method comprising:
applying a preflush fluid to at least a portion of a subterranean formation;
applying a resin composition to the portion of the subterranean formation, the resin composition comprising
a liquid hardenable resin component that comprises a hardenable resin and a solvent, and
a liquid hardening agent component that comprises a hardening agent, a solvent, a silane coupling agent, and a non-ionic surfactant; and
applying a compatible afterflush fluid to the portion of the subterranean formation.

2. The method of claim 1 wherein the preflush fluid comprises at least one of the following: an aqueous liquid; a non-aqueous liquid; or a derivative thereof.

3. The method of claim 1 wherein the preflush fluid comprises at least one of the following: kerosene; diesel; or a derivative thereof.

4. The method of claim 1 wherein the compatible afterflush fluid comprises at least one of the following: an aqueous liquid; a non-aqueous liquid; or a derivative thereof.

5. The method of claim 1 wherein the compatible afterflush fluid comprises a liquid comprising at least one hydrocarbon.

6. The method of claim 1 wherein the compatible afterflush fluid comprises at least one of the following: kerosene; diesel; or a derivative thereof.

7. The method of claim 1 wherein the hardenable resin comprises at least one of the following: bisphenol A diglycidyl ether resin; butoxymethyl butyl glycidyl ether resin; bisphenol A-epichlorohydrin resin; polyepoxide resin; novolak resin; polyester resin; phenol-aldehyde resin; urea-aldehyde resin; furan resin; urethane resin; or a glycidyl ether resin; or a derivative thereof.

8. The method of claim 1 wherein the hardening agent comprises at least one of the following: piperazine; 2H-pyrrole; pyrrole; imidazole; pyrazole; pyridine; pyrazine; pyrimidine; pyridazine; indolizine; isoindole; 3H-indole; indole; 1H-indazole; purine; 4H-quinolizine; quinoline; isoquinoline; phthalazine; naphthyridine; quinoxaline; quinazoline; 4H-carbazole; carbazole; β-carboline; phenanthridine; acridine; phenathroline; phenazine; imidazolidine; phenoxazine; cinnoline; pyrrolidine; pyrroline; imidazoline; piperidine; indoline; isoindoline; quinuclindine; morpholine; azocine; azepine; 2H-azepine; 1,3,5-triazine; thiazole; pteridine; dihydroquinoline; hexa methylene imine; indazole; an amine; an aromatic amine; a polyamine; an aliphatic amine; a cyclo-aliphatic amine; an amide; a polyamide; 2-ethyl-4-methyl imidazole; 1,1,3-trichlorotrifluoroacetone; or a derivative thereof.

9. The method of claim 1 wherein the silane coupling agent comprises at least one of the following: N-β-(aminoethyl)-γ-aminopropyl trimethoxysilane; N-2-(aminoethyl)-3-aminopropyltrimethoxysilane; or 3-glycidoxypropyltrimethoxysilane; or a derivative thereof.

10. The method of claim 1 wherein the resin composition further comprises a hydrolysable ester.

11. The method of claim 1 wherein the resin composition further comprises a diluent or liquid carrier fluid.

12. The method of claim 1 wherein the temperature in the portion of the subterranean formation is in the range of from about 200° F. to about 400° F.

13. The method of claim 1 further comprising waiting a sufficient amount of time for the hardenable resin to cure.

14. A method of stabilizing a relatively unconsolidated portion of a subterranean formation comprising:
applying a preflush fluid to the portion of the subterranean formation;
applying a resin composition to the portion of the subterranean formation, the resin composition comprising
a liquid hardenable resin component that comprises a hardenable resin and a solvent, and
a liquid hardening agent component that comprises a hardening agent, a solvent, a silane coupling agent, and a non-ionic surfactant; and
applying a compatible afterflush fluid to the portion of the subterranean formation.

15. The method of claim 14 wherein the compatible afterflush fluid comprises at least one of the following: kerosene; diesel; or a derivative thereof.

16. The method of claim 14 further comprising waiting a sufficient amount of time for the hardenable resin to cure.

17. The method of claim 14 wherein the temperature in the portion of the subterranean formation is in the range of from about 200° F. to about 400° F.

18. A method of creating a permeable, consolidated formation sand pack in a relatively unconsolidated portion of a subterranean formation comprising:
applying a preflush fluid to the portion of the subterranean formation;
applying a resin composition to the portion of the subterranean formation, the resin composition comprising
a liquid hardenable resin component that comprises a hardenable resin and a solvent, and
a liquid hardening agent component that comprises a hardening agent, a solvent, a silane coupling agent, and a non-ionic surfactant;
applying a compatible afterflush fluid to the portion of the subterranean formation; and
waiting a sufficient amount of time for the hardenable resin to cure so as to form a permeable, consolidated formation sand pack.

19. The method of claim 18 wherein the compatible afterflush fluid comprises at least one of the following: kerosene; diesel; or a derivative thereof.

20. The method of claim 18 wherein the temperature in the portion of the subterranean formation is in the range of from about 200° F. to about 400° F.
